(19) United States
(12) Patent Application Publication
(10) Pub. No.: US 2023/0047707 A1
(43) Pub. Date: Feb. 16, 2023

(54) THERMALLY CONDUCTIVE FILLER, THERMALLY CONDUCTIVE COMPOSITE MATERIAL, WIRE HARNESS, AND METHOD FOR MANUFACTURING THERMALLY CONDUCTIVE FILLER

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(72) Inventors: Naoyuki OSHIUMI, Yokkaichi-shi (JP); Takehiro HOSOKAWA, Yokkaichi-shi (JP); Kazuo NAKASHIMA, Yokkaichi-shi (JP); Takashi KAWAKAMI, Yokkaichi-shi (JP); Yusaku MAEDA, Yokkaichi-shi (JP); Makoto MIZOGUCHI, Fukuoka-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); KYUSHU UNIVERSITY, NATIONAL UNIVERSITY CORPORATION, Fukuoka-shi, Fukuoka (JP)

(21) Appl. No.: 17/788,584

(22) PCT Filed: Dec. 4, 2020
(86) PCT No.: PCT/JP2020/045166

§ 371 Date: Jun. 23, 2022

(30) Foreign Application Priority Data
Dec. 23, 2019 (JP) 2019-231048

(51) Int. Cl. C09K 5/14; C08K 3/22; C08K 9/06; C08K 7/24

(52) U.S. Cl. CPC C09K 5/14; C08K 3/22; C08K 9/06; C08K 7/24

(57) ABSTRACT

A thermally conductive filler capable of exhibiting high thermal conductive properties with its specific gravity being reduced, a thermally conductive composite material and a wire harness that contains such a thermally conductive filler, and a method for forming a thermally conductive filler that can be used to form such a thermally conductive filler. A thermally conductive filler includes a hollow particle having a polar group on its surface, and a thermally conductive layer containing an inorganic compound that covers the surface of the hollow particle. Also, a thermally conductive composite material contains the thermally conductive filler and a matrix material, the thermally conductive filler being dispersed in the matrix material. Furthermore, a wire harness contains the thermally conductive composite material.

### TECHNICAL FIELD

The present disclosure relates to a thermally conductive filler, a thermally conductive composite material, a wire harness, and a method for manufacturing a thermally conductive filler.

### BACKGROUND ART

A thermally conductive filler may be added to an organic polymer material for the purpose of enhancing heat dissipation properties and reducing the influence of heat generation caused by the application of an electric current or the like in an insulating member contained in an electric/electronic component. The thermally conductive filler generally contains an inorganic compound having high thermal conductive properties, such as alumina, aluminum nitride, or boron nitride.

In recent years, various electric/electronic components such as car electronics have been made more adaptable to large electric currents and have become more integrated, and the amount of heat generated due to the application of an electric current is on the rise. As a means for suppressing the influence of generated heat, the heat dissipation properties have been enhanced by making improvements to the shapes and structures of members. For example, in the case of a wire harness for an automobile, electric wires may be flattened to increase the surface areas of the electric wires, or the electric wires may be efficiently in contact with a sheathing member having high thermal conductive properties. Meanwhile, in order to enhance the heat dissipation properties, it is also important to enhance the thermal conductive properties of materials of insulating members such as an electric wire coating and an electric wire sheathing member of an electric/electronic component.

Mixing a large amount of a filler to an organic polymer material and the like makes it possible to enhance the thermal conductive properties of the material, but mixing a large amount of a filler made of an inorganic compound to an organic polymer material increases the specific gravity of the material, thus making it difficult to reduce the weight of an electric/electronic component. It is important to reduce the weight of an electric/electronic component for an automobile from the viewpoint of reducing the overall weight of an automobile. Accordingly, it is desirable to reduce the weight of a material containing a thermally conductive filler. As a method for achieving this, an attempt has been made to reduce the addition amount of a filler.

The shape of a filler and the filler particle arrangement have been improved for the purpose of maintaining high thermal conductive properties while the addition amount of the filler is reduced. For example, Patent Literature 1 discloses a filler that has a void thereinside and has a void ratio within a predetermined range. Patent Literature 2 discloses an inorganic-organic composite composition obtained by dispersing, in a resin serving as a matrix, boron nitride particles in the form of exfoliated flat particles generated through an exfoliation step of delaminating a secondary particle, which is a laminate of primary particles. Patent Literature 3 discloses a complex having high thermal conductive properties in which fillers having shape anisotropy and high thermal conductive properties are in direct contact with one another and form a network structure in a matrix resin.

### CITATION LIST

### Patent Literature

Patent Literature 1: JP 2019-1849 A
Patent Literature 2: JP 2012-255055 A
Patent Literature 3: JP 2010-13580 A
Patent Literature 4: JP 2012-122057 A
Patent Literature 5: JP 2015-178543 A
Patent Literature 6: JP 2015-108058 A
Patent Literature 7: JP 2003-221453 A

### SUMMARY OF INVENTION

### Technical Problem

Inorganic compounds typified by alumina, aluminum nitride, and boron nitride have high thermal conductive properties, but have a high specific gravity. Accordingly, when such an inorganic compound is added, as a filler, to an organic polymer material or the like to forma composite material, it is difficult to achieve high thermal conductive properties while keeping the overall specific gravity of the composite material low. In particular, a filler made of an oxide such as alumina tends to have a high specific gravity. As described in Patent Literatures 1 to 3, the addition amount of the inorganic compound can be reduced to some extent by improving the shape of the filler and the filler particle arrangement, but such an improvement has its limitations. If the specific gravity of the filler itself can be reduced by investigating the constituent materials of the filler, there is a possibility that both the weight reduction and the high thermal conductive properties of a composite material to which the filler has been added can be achieved to a higher degree.

Therefore, it is an object of the present invention to provide a thermally conductive filler capable of exhibiting high thermal conductive properties with its specific gravity being reduced, a thermally conductive composite material and a wire harness that contain such a thermally conductive filler, and a method for manufacturing a thermally conductive filler that can be used to form such a thermally conductive filler.

### Solution to Problem

A thermally conductive filler according to the present disclosure contains: a hollow particle having a polar group on its surface; and a thermally conductive layer containing an inorganic compound that covers the surface of the hollow particle.

A thermally conductive composite material according to the present disclosure contains: the thermally conductive filler; and a matrix material, wherein the thermally conductive filler is dispersed in the matrix material.

A wire harness according to the present disclosure contains the thermally conductive composite material.

A method for manufacturing a thermally conductive filler according to the present disclosure is used to form the thermally conductive filler, and the method uses a raw material for forming the thermally conductive layer as it is or through chemical reaction, and a raw particle formed as a hollow particle having a polar group on its surface, and the method includes a step of binding the raw material onto the polar group on the surface of the raw particle.

### Advantageous Effects of Invention

The thermally conductive filler according to the present disclosure is a thermally conductive filler capable of exhibiting high thermal conductive properties with its specific gravity being reduced. The thermally conductive composite material and the wire harness according to the present disclosure contain such a thermally conductive filler. The method for manufacturing a thermally conductive filler according to the present disclosure can be used to form such a thermally conductive filler.

### BRIEF DESCRIPTION OF DRAWINGS

FIG. 1 is a schematic diagram illustrating the configurations of a thermally conductive filler and a thermally conductive composite material according to an embodiment of the present disclosure.

FIG. 2 is a side view of a wire harness according to an embodiment of the present disclosure.

### DESCRIPTION OF EMBODIMENTS

### Description of Embodiments of the Present Disclosure

First, embodiments of the present disclosure will be listed and described.

A thermally conductive filler according to the present disclosure contains: a hollow particle having a polar group on its surface; and a thermally conductive layer containing an inorganic compound that covers the surface of the hollow particle.

The thermally conductive filler contains a hollow particle as a constituent material, and has a thermally conductive layer containing an inorganic compound on the surface of the hollow particle. The hollow particle has a cavity thereinside and thus the overall specific gravity thereof is low. Accordingly, the overall specific gravity of the thermally conductive filler that contains the hollow particle is lower than that of a thermally conductive filler made of only an inorganic compound. Meanwhile, the thermally conductive layer containing an inorganic compound covers the surface of the hollow particle in the thermally conductive filler particle, and therefore, the filler particles are in contact with other filler particles or other materials surrounding the filler particles via the thermally conductive layers. Accordingly, even if the hollow particle itself does not have high thermal conductive properties, the filler particle can exhibit high thermal conductive properties as a whole due to the thermally conductive layer covering the surface of the hollow particle. This makes it possible to secure high thermal conductive properties of the thermally conductive filler while reducing its specific gravity.

The hollow particle has a polar group on its surface, thus making it likely for the inorganic compound contained in the thermally conductive layer or a raw material of the inorganic compound to be bound to the surface of the hollow particle through interaction or chemical reaction with the polar group. As a result, it is possible to stably and easily form the thermally conductive filler containing a hollow particle and a thermally conductive layer covering the hollow particle.

Here, it is preferable that the polar group is an acidic group. The acidic group is negatively charged, and thus stably forms an ionic bond with a positively charged inorganic compound or a raw material of the inorganic compound. Accordingly, it is possible to stably and easily form the thermally conductive layer containing an inorganic compound on the surface of the hollow particle.

It is preferable that the polar group is bound to the surface of the hollow particle via a siloxane bond. In the case where the hollow particle has a silicon atom on its surface, a siloxane bond can be easily formed on the surface of the hollow particle using a silane coupling agent. Using a silane coupling agent that includes a polar group such as an acidic group or a silane coupling agent that includes a functional group capable of forming a bond with a compound having a polar group makes it possible to stably introduce various polar groups to the surface of the hollow particle.

It is preferable that the hollow particle is formed as a hollow body made of a material containing an inorganic compound that is different from the inorganic compound contained in the thermally conductive layer, or a material containing an organic polymer. As a result, a thermally conductive filler that has a low specific gravity and excellent thermal conductive properties can be formed using hollow particles made of various materials.

It is preferable that the hollow particle is formed as a hollow body made of glass surface treated with a polar group. Various polar groups can be easily introduced to the surface of a glass particle using a silane coupling agent. Hollow glass particles having a controlled particle diameter and a controlled shape can be obtained relatively easily and inexpensively.

It is preferable that the thermally conductive layer contains a compound containing at least one of Al or Mg. Al compounds and Mg compounds including oxides thereof exhibit high thermal conductive properties. Alkoxides and carbonates of Al and Mg, which can be used as a raw material compound capable of being bound to the surface of the hollow particle and forming a stable film of compound, are easily obtained. Accordingly, using a compound containing Al or Mg to form the thermally conductive layer makes it possible to easily form the thermally conductive filler having both a low specific gravity and high thermal conductive properties.

It is preferable that the thermally conductive filler has a specific gravity of 1.5 or lower. This makes it possible to keep the specific gravity of the thermally conductive filler sufficiently low.

A thermally conductive composite material according to the present disclosure contains: the thermally conductive filler; and a matrix material, wherein the thermally conductive filler is dispersed in the matrix material.

The thermally conductive composite material contains the above-described thermally conductive filler that contains the hollow particle and the thermally conductive layer covering the surface of the hollow particle. Accordingly, it is possible to enhance the heat dissipation properties utilizing the high thermal conductive properties of the thermally conductive filler while reducing the overall specific gravity of the thermally conductive composite material.

Here, it is preferable that the matrix material contains an organic polymer. Many organic polymers have low thermal conductive properties, but mixing with the thermally conductive filler having the thermally conductive layer on its surface makes it possible to keep the overall heat dissipation properties of high thermally conductive composite material. On the other hand, many organic polymers have a relatively low specific gravity, but since the thermally conductive filler to be mixed contains the hollow particle and thus has a reduced specific gravity, the specific gravity of the thermally conductive composite material can be reduced even in the state in which the thermally conductive filler is added thereto.

It is preferable that the thermally conductive composite material has a specific gravity of 1.5 or lower. In this case, the overall specific gravity of the thermally conductive composite material is sufficiently reduced.

It is preferable that the thermally conductive composite material has a thermal conductivity of 0.9 W/(m·K) or higher at room temperature. In this case, the overall thermal conductive properties of the thermally conductive composite material is kept sufficiently high.

A wire harness according to the present disclosure contains the thermally conductive composite material.

The wire harness contains the above-described thermally conductive composite material, thus making it possible to utilize the high thermal conductive properties while reducing the specific gravities of constituent members. Accordingly, it is possible to achieve high heat dissipation properties while reducing the overall mass of the wire harness. Therefore, even if heat is generated due to the application of an electric current to electric wires constituting the wire harness, and the like, it is possible to reduce the influence of the heat generation while maintaining the lightness of the wire harness.

A method for manufacturing a thermally conductive filler according to the present disclosure is used to form the thermally conductive filler, and the method includes a raw material for forming the thermally conductive layer as it is or through chemical reaction, and a raw particle formed as a hollow particle having a polar group on its surface, and the method includes a step of binding the raw material onto the polar group on the surface of the raw particle.

With the above-mentioned forming method, the thermally conductive layer containing an inorganic compound is formed on the raw particle in the form of a hollow particle, and thus a thermally conductive filler having a low specific gravity and high thermal conductive properties can be easily formed. Using the raw particle having a polar group on its surface makes it possible to stably and easily bind the raw material for forming the thermally conductive layer to the surface of the raw particle via the polar group.

Here, it is preferable that the raw material is at least one of a metal alkoxide or a metal carbonate. This makes it possible to obtain the thermally conductive filler by forming the thermally conductive layer containing a metal oxide on the surface of the raw particle through a simple chemical reaction process.

### Details of Embodiments of the Present Disclosure

Hereinafter, a thermally conductive filler, a thermally conductive composite material, a wire harness, and a method for manufacturing a thermally conductive filler according to embodiments of the present disclosure will be described with reference to the drawings. The thermally conductive composite material according to an embodiment of the present disclosure contains the thermally conductive filler according to an embodiment of the present disclosure. Also, the wire harness according to an embodiment of the present disclosure contains the thermally conductive composite material according to the embodiment of the present disclosure. Furthermore, the thermally conductive filler according to the embodiment of the present disclosure can be formed using the forming method according to an embodiment of the present disclosure.

In this specification, various physical property values are measured at room temperature in the atmosphere unless otherwise specified. In this specification, the expression “a component is a main component of a material” refers to a state in which the component makes up 50 mass % or more of the total mass of the all components contained in the material.

### Thermally Conductive Filler

First, the thermally conductive filler (also referred to merely as a “filler” hereinafter) according to an embodiment of the present disclosure will be described.

### Overall Configuration

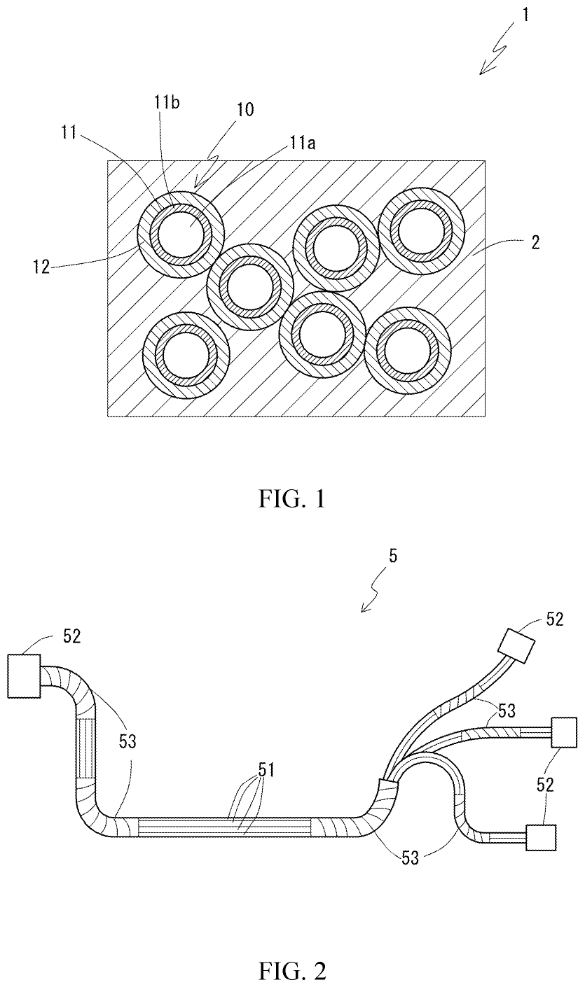

As shown in FIG. 1, a thermally conductive filler 10 according to an embodiment of the present disclosure contains a hollow particle 11 and a thermally conductive layer 12, and has a particulate shape. The thermally conductive layer 12 covers the surface of the hollow particle 11.

The hollow particle 11 is a particle having a cavity 11a thereinside. The cavity 11a is filled with a gas typified by air excluding a solid component or liquid component that is inevitably mixed in during the process for forming the hollow particle 11 or the filler 10. Specific constituent materials of the hollow particle 11 and the thermally conductive layer 12 will be described later. The hollow particle 11 is made of a material different from that of the thermally conductive layer 12, and has a polar group, namely a functional group having a polarity, on its surface (outer surface). Meanwhile, the thermally conductive layer 12 is formed as a layer containing an inorganic compound.

The hollow particle 11 has the cavity 11a filled with a gas such as air thereinside, and thus the overall specific gravity and the thermal conductive properties of the particle are lower compared with a solid particle that has no cavity and is made entirely of a solid mate. Accordingly, the specific gravity and the thermal conductive properties of the hollow particle 11 are lower than those of the thermally conductive layer 12 formed as an inorganic compound layer. The thermally conductive filler 10 according to this embodiment obtained by providing the thermally conductive layer 12 on the surface of the hollow particle 11 contains the hollow particle 11 having a low specific gravity, and therefore, the overall specific gravity of the filler 10 can be reduced compared with a conventionally common filler that is made entirely of an inorganic compound.

Meanwhile, the thermally conductive layer 12 covering the surface of the hollow particle 11 contains an inorganic compound, and thus the thermal conductive properties thereof can be enhanced, thus making it possible to enhance the overall thermal conductive properties of the filler 10. As shown in FIG. 1, the thermally conductive layer 12 on the surface of the filler particle 10 is in contact with a matrix material 2 surrounding the filler particle 10 and the thermally conductive layer 12 on the surface of another filler particle 10, which contributes to thermal conduction between the filler particle 10 and the matrix material 2, and between the filler particles 10. Since the thermally conductive layer 12 is provided only on the surface of the hollow particle 11, the overall volume of the filler particle 10 is secured by the hollow particle 11, while thermal conductive properties can be exhibited by the thermally conductive layer 12 with a small volume. A thermal conduction path can be formed due to mutual contact between the adjacent filler particles 10 via the outermost thermally conductive layers 12.

The overall specific gravity of the filler 10 is preferably 1.5 or lower, more preferably 1.2 or lower, and even more preferably 1.0 or lower, from the viewpoint of avoiding an increase in the mass of the filler 10. On the other hand, the overall specific gravity of the filler 10 is preferably 0.3 or higher, and more preferably 0.5 or higher, from the viewpoint of avoiding failure to form the thermally conductive layer 12 having a sufficient thickness due to an excessive reduction in the specific gravity. The specific gravity of the filler 10 can be measured, for example, as the true density of the powdered filler 10 using a densimeter. The overall specific gravity of the filler 10 is used as a specific gravity R2 in Formula (1), which will be described later as a formula for describing the ratio of the thermally conductive layer 12. Next, the details of the configurations of the hollow particle 11 and the thermally conductive layer 12 will be described.

### Hollow Particle

As mentioned above, the hollow particle 11 is a granular body having the cavity 11a. Here, the cavity 11a is a space surrounded entirely by a shell 11b that is made of a solid material and contained in the hollow particle 11, and thus is secluded from the environment outside the hollow particle 11. The hollow particle 11 does not have a porous structure, other than an inevitably formed porous structure, like a porous body communicating with the outside environment.

There is no specific limitation on the material of (the shell 11b of) the hollow particle 11, however it is preferable that the hollow particle 11 is made of an organic substance or an inorganic substance that is different from the inorganic compound contained in the thermally conductive layer 12. Examples of the organic substance include organic polymers (that encompass polymers as well as substances having a low polymerization degree such as oligomers) such as various resins, elastomers, and rubbers. Examples of the inorganic substance include inorganic compounds such as metals, glass, and ceramics. Only one type of material may be used to form the hollow particle 11, or two or more types of materials may be used together as a mixture or in lamination to form the hollow particle 11. The hollow particle 11 may also be made of a composite material containing an organic material and an inorganic material.

A preferable example of the constituent material of the hollow particle 11 is glass. Since glass is a material having a relatively low specific gravity among various inorganic compounds and having higher thermal conductive properties than organic polymers and the like, using glass as a material of the hollow particle 11 contained in the thermally conductive filler 10 is highly effective in reducing the specific gravity of the thermally conductive filler 10 and enhancing the thermal conductive properties thereof. In addition, the techniques for producing a hollow particle using glass and controlling the particle diameter and the shape have already been established. Further, a hollow glass particle can be obtained at a lower cost compared with other types of hollow particles. There is no specific limitation on the type of glass contained in the hollow particle 11, and various types of glass such as soda lime glass, silica glass, borate glass, borosilicate glass, lead glass, and phosphate glass can be used. Of these types of glass, it is preferable to use glass that has, in its structure, a silicon atom capable of forming a siloxane bond with a silane coupling agent, such as soda lime glass, silica glass, borosilicate glass, or soda lime borosilicate glass, with the aim of enabling introduction of a polar group using a silane coupling agent as described later.

The hollow particle 11 has a polar group on its surface. Due to the presence of a polar group on the surface of the hollow particle 11, when a raw material for forming the thermally conductive layer 12 is bond onto the surface of a raw particle for forming the hollow particle 11 to form the thermally conductive layer 12 as described later, the bonding is established between the polar group of the raw particle and the raw material, and thus a stable thermally conductive layer 12 can be easily formed. The entire shell 11a of the hollow particle 11 may contain a compound having a polar group as a constituent material, or a polar group may be introduced only to the surface (and the vicinity thereof) of the hollow particle 11 made of a material that contains substantially no polar groups or a very small amount of polar groups, through surface treatment or the like. Herein, the structure of the polar group present on the surface of the raw particle may change or the polarity thereof may be reduced or lost through the formation of the thermally conductive layer 12, but even in such a case, a structure that is derived from the original polar group and that remains on the surface of the hollow particle 11 in the formed filler 10 is referred to as a “polar group”.

The type of polar group provided on the surface of the hollow particle 11 (or the raw particle on which the thermally conductive layer 12 has not been formed yet; the same applies to descriptions of a polar group on the surface hereinafter) is not particularly limited, and may be an ionic polar group or a nonionic polar group. Examples of the ionic polar group include acidic groups such as a carboxyl group, a silanol group, a sulfonate group, a phosphate group, and a phenolic hydroxyl group, and a basic group such as an amino group. Examples of the nonionic or weakly ionizable polar group include an alcoholic hydroxyl group, an isocyanate group, an epoxy group, and an alkoxysilyl group. It is preferable that the hollow particle 11 has an ionic polar group on its surface from the viewpoint of forming an ionic bond with the raw material and stably binding the raw material onto the surface of the raw particle when forming the thermally conductive layer 12.

The polar group may have a positive polarity or negative polarity. However, many raw materials such as metal compounds used to form the thermally conductive layer 12 are positively charged. Thus, it is preferable that the polar group on the surface of the hollow particle 11 has a negative polarization in the direction away from the surface of the hollow particle 11 as typified by various acidic groups, from the viewpoint of electrostatically binding the raw materials firmly to the surface of the hollow particle 11. A bipolar compound such as an amino acid may be bound to the surface of the hollow particle 11 to provide a polar group. A form in which an acidic group, which is an ionic polar group having a negative polarization, is present on the surface of the hollow particle 11 is particularly preferable. Furthermore, it is preferable that the polar group does not exhibit a strong hydrogen-bond forming ability or reactivity with a substance present the re around from the viewpoint of preventing aggregation of the hollow particles 11 via the polar group. Many acidic groups such as a carboxyl group do not have a strong hydrogen-bond forming ability or reactivity with a substance such as a solvent molecule present therearound, and such acidic groups can be favorably employed as the polar group.

The polar group may be bound to the skeleton structure of the hollow particle 11 directly or via another bond. Various polar groups can be introduced to the surface of the hollow particle 11 via intervention of another bond. For example, when glass containing a silicon atom constitutes the skeleton structure of the hollow particle 11, a polar group can be introduced to the surface of the hollow particle 11 via a siloxane bond (—Si—O—Si—). As will be described later, a polar group can be easily introduced via a siloxane bond through surface treatment using a silane coupling agent. Apolar group may be bound to the surface of the hollow particle 11 via yet another bond in addition to a siloxane bond. For example, when a silane coupling agent having an isocyanate group is bound to the surface of the hollow particle 11 via a siloxane bond, and then an amino group of an amino acid is reacted to the isocyanate group, a structure in which a carboxyl group is bound to the surface of the hollow particle 11 via a urea bond in addition to the siloxane bond can be formed.

When the hollow particle 11 contains an inorganic substance including glass, it is preferable to introduce a polar group to the surface portion through surface treatment such as the aforementioned treatment using a silane coupling agent, from the viewpoint of easily introducing a polar group onto the surface of the hollow particle 11. On the other hand, when the hollow particle 11 contains an organic substance, it is preferable that the organic substance contained in the hollow particle 11 itself has a polar group, and the polar group is exposed on the surface of the hollow particle 11. Examples of organic polymers having a polar group include polymers (copolymers) containing an acrylic acid in its main chain, and acid-modified polymers.

There are no limitation on the specific shape and particle diameter of the hollow particle 11 as long as it has the cavity 11a thereinside. However, it is preferable that the hollow particle 11 has a highly isotropic shape such as a shape that can be approximated by a sphere because, for example, the thermally conductive layer 12 can be easily formed on the surface, and the affinity with the matrix material 2 is enhanced. The particle diameter (median diameter D50; the same applies hereinafter) of the hollow particle 11 is preferably 1 μm or more, and more preferably 5 μm or more, from the viewpoint of reducing the overall specific gravity of the filler 10. On the other hand, the particle diameter of the hollow particle 11 is preferably 100 μm or less, and more preferably 60 μm or less, from the viewpoint of reducing the influence on the properties of the matrix material 2 to which the filler 10 is added, increasing the specific surface area.

It is preferable that the hollow particle 11 itself also has a low specific gravity from the viewpoint of reducing the overall specific gravity of the filler 10. Specifically, there is no particular limitation on the specific gravity of the hollow particle 11 as long as the overall specific gravity of the hollow particle 11 is lower than the specific gravity of the thermally conductive layer 12. It is preferable that the overall specific gravity (true density) of the hollow particle 11 including the cavity 11a is, for example, 1.0 or lower, preferably 0.5 or lower, and more preferably 0.3 or lower. The lower limit of the specific gravity of the hollow particle 11 is not particularly set. A hollow particle 11 made of an inorganic material such as glass or an organic polymer has a specific gravity of about 0.1 or higher. It is preferable that the specific gravity of the hollow particle 11 in terms of the overall specific gravity of the hollow particle 11 including the cavity 11a should be sufficiently low. Further, it is also preferable that the material contained in the shell 11b of the hollow particle 11 itself has a low specific gravity. For example, the specific gravity of the material contained in the shell 11b is preferably lower than or equal to the specific gravity of the thermally conductive layer 12, and more preferably lower than or equal to a half of the specific gravity of the thermally conductive layer 12.

### Thermally Conductive Layer

As mentioned above, the thermally conductive layer 12 is formed as a layer containing an inorganic compound (excluding alloys). It is preferable that the thermally conductive layer 12 contains an inorganic compound as a main component. There is no specific limitation on the type of inorganic compound, but a substance having a higher thermal conductivity than the hollow particle 11 is used. That is, the substance is used that has a greater effect of improving thermal conductivity in the case where the hollow particles 11 having the thermally conductive layers 12 on the surfaces are mixed in the matrix material 2 rather than in the case where the hollow particles 11 only are mixed in the matrix material 2. It is preferable that the thermal conductivity of the inorganic compound contained in the thermally conductive layer 12 is higher than that of the matrix material 2, and is also higher than that of the constituent material of the shell 11b of the hollow particle 11. It is preferable that the thermally conductive layer 12 contains, as the inorganic compound, a metal compound containing metallic and non-metallic elements from the viewpoint of easily forming a stable thermally conductive layer 12 having high thermal conductive properties on the particle surface of the hollow particle 11. Here, the metallic element contained in the metal compound encompasses semimetals such as B and Si (the same applies hereinafter).

Examples of the metal compound contained in the thermally conductive layer 12 include: oxides, nitrides, carbides, oxynitrides, carbonitrides, carbonates, hydroxides, and borides that contain a metallic element; metal silicates; metal aluminates; and metal titanates. It is preferable that the thermally conductive layer 12 contains a metal oxide out of the various metal compounds from the viewpoint of providing excellent thermal conductive properties and enabling a film-like thermally conductive layer 12 to be easily and stably formed on the surface of the hollow particle 11. It is particularly preferable that the thermally conductive layer 12 contains a metal oxide as a main component. Metal oxides are likely to have a higher specific gravity than metal nitrides and metal carbides. Therefore, if a metal oxide is used to form the thermally conductive layer 12 coexisting with the hollow particle 11 in the filler 10, the effect of the reduced specific gravity of the hollow particle 11 can be greatly enjoyed.

It is preferable that the inorganic compound contained in the thermally conductive layer 12 includes a compound containing at least one of Al and Mg out of the various metal compounds. It is particularly preferable that Al is contained. An Al oxide and a Mg oxide are preferable. Al compounds and Mg compounds including oxides thereof exhibit high thermal conductive properties. By using these compounds, a film-like thermally conductive layer 12 can be securely and firmly formed onto the surface of the particulate hollow particle 11 using a commercially available raw material compound with easiness.

The thermally conductive layer 12 may include one type of inorganic compound or a plurality of types of inorganic compounds. When a plurality of inorganic compounds are used, the inorganic compounds may be mixed together or form a complex or be laminated into a layer form. Furthermore, the thermally conductive layer 12 may contain not only the inorganic compound but also an organic substance such as various additives or a reaction residue. When the matrix material 2 contains an organic polymer, an organic film may be provided on the surface of the thermally conductive layer 12 from the viewpoint of, for example, enhancing affinity with the matrix material 2. However, it is preferable that such an organic film is not provided from the viewpoint of enhancing the thermal conductive properties obtained by the thermally conductive layers 12 of the adjacent filler particles 10 having direct contact with each other. It is sufficient that the thermally conductive layer 12 covers at least a portion of the surface of the hollow particle 11, but the thermally conductive layer 12 preferably covers an area larger than or equal to a half of the surface area of the hollow particle 11, and more preferably the entire surface of the hollow particle 11 excluding inevitable defects, from the viewpoint of sufficiently maintaining contact via the thermally conductive layer 12 between the filler particles 10 and the matrix material 2 and between the adjacent filler particles 10.

There is no particular limitation on the ratio of the thermally conductive layer 12 in the filler 10, but the specific gravity ratio R of the thermally conductive layer defined by Formula (1) below is preferably 100% or more.

R=(R2-R1)/R1 (1)

In this formula, R1 represents the specific gravity of only the hollow particle 11, and R2 represents the overall specific gravity of the filler 10. The larger the specific gravity ratio R of the thermally conductive layer is, the larger the ratio of a region in which the thermally conductive layer 12 is present in the filler 10 is. The state of the hollow particle 11 is substantially unchanged by the formation of the thermally conductive layer 12, and therefore, the specific gravity of the raw particle used to form the filler 10 can be used as the specific gravity R1 of the hollow particle 11.

If the specific gravity ratio R of the thermally conductive layer is 100% or more, the filler 10 has a thermally conductive layer 12 with a substantive volume, and thus the overall thermal conductive properties of the filler 10 is readily enhanced sufficiently. The specific gravity ratio R of the thermally conductive layer is more preferably 150% or more, and even more preferably 300% or more. The volume ratio of the thermally conductive layer 12 to the entire filler 10 is preferably 5 vol % or more, more preferably 10 vol % or more, and even more preferably 20 vol % or more. The average thickness of the thermally conductive layer 12 preferably corresponds to 1% or more of the particle diameter of the filler particle 10, more preferably 3% or more thereof, and even more preferably 5% or more thereof.

On the other hand, if the ratio of the thermally conductive layer 12 in the filler particle 10 is excessively large, the effect of enhancing the thermal conductive properties of the filler 10 will be saturated, and the effect of reducing the specific gravity of the filler particle 10 obtained due to containment of the hollow particle 11 will be lowered. It is preferable that the specific gravity ratio R of the thermally conductive layer is 500% or less from the viewpoint of avoiding such phenomena. It is preferable that the amount of the thermally conductive layer 12 is selected such that the volume ratio of the thermally conductive layer 12 with respect to the entire filler particle 10 is 40 vol % or less and the thickness of the thermally conductive layer 12 is 15% or less with respect to the particle diameter of the filler particle 10. The region in which the thermally conductive layer 12 is present in the filler particle 10 is small with respect to the particle diameter of the hollow particle 11, and therefore, the overall particle diameter of the filler particle 10 is not significantly different from the particle diameter of the hollow particle 11, and is preferably 1 μm or more and more preferably 5 μm or more as well as preferably 100 μm or less and more preferably 60 μm or less.

As described above, the thermally conductive filler 10 according to this embodiment has a double-layered structure in which the thermally conductive layer 12 is formed on the surface of the hollow particle 11, and thus the specific gravity of the filler 10 is reduced while the thermal conductive properties of the filler 10 are kept high. Accordingly, where the thermally conductive filler 10 is used along with another substance to form a composite material in the same manner as a thermally conductive composite material 1, which will be described later, the thermal conductive properties of the composite material is enhanced without significantly increasing the overall specific gravity of the composite material.

### Method for Manufacturing Thermally Conductive Filler

Next, a method for manufacturing a thermally conductive filler according to an embodiment of the present disclosure that can be used to form the above-mentioned thermally conductive filler 10 will be described. The thermally conductive filler 10 can be formed by performing a particle preparation step and a thermally conductive layer formation step.

In the particle preparation step, a hollow raw particle to serve as the hollow particle 11 in the formed filler 10 is prepared. Hollow-particle forming methods in which various organic materials and inorganic materials are used have been developed, and thus it is sufficient that the raw particle is prepared in accordance with these methods. Many types of hollow particles made of inorganic compounds such as glass and organic macromolecules are commercially available.

When the raw particle does not have a polar group on its surface, or the surface polarity thereof is not sufficiently high due to a low polar group density, surface treatment is performed on the raw particle to introduce a polar group to the surface. It is sufficient that, in the surface treatment, a compound having a desired polar group is bound to the surface of the raw particle through a chemical reaction. At this time, another compound may be provided between the compound having the polar group and the surface of the raw particle.

When the raw particle is made of glass containing a silicon atom, it is preferable to use a silane coupling agent to introduce a polar group to the surface of the raw particle via a siloxane bond. In general, a silane coupling agent has an alkoxysilyl group. When the silane coupling agent is bound to the surface of the raw particle, the alkoxysilyl group remaining on the surface of the raw particle or a silanol group generated through hydrolysis of the alkoxysilyl group, or a siloxane bond formed through a reaction between the adjacent alkoxysilyl groups functions as a polar group on the surface of the raw particle. If a silane coupling agent to be used in the surface treatment includes a polar functional group in addition to an alkoxysilyl group, this functional group can be introduced, as a polar group, to the surface of the raw particle in addition to the alkoxysilyl group.

If a silane coupling agent having a reactive functional group other than an alkoxysilyl group is used, it is also possible to introduce a polar group to the surface of the raw particle by binding the silane coupling agent to the surface of the raw particle and then further binding another compound (compound of another type) thereto via the reactive functional group. In this case, it is preferable that a compound having a reactive group capable of reacting with the reactive group contained in the silane coupling agent to form a bond in addition to a polar group to be introduced to the surface of the raw particle is used as the compound of another type to be bound to the raw particle via the silane coupling agent. Examples of the reactive functional group that can be introduced to the silane coupling agent for the purpose of binding the compound of another type thereto include an isocyanate group, an epoxy group, a vinyl group, an amino group, and a mercapto group. In an exemplary aspect, when a silane coupling agent having, for example, an isocyanate group is used, a compound having an amino group in addition to a polar group to be introduced to the surface of the raw particle can be used as the compound of another type to be bound to the silane coupling agent. In this case, a urea bond is formed between the isocyanate group and the amino group, and thus the compound of another type is bound to the surface of the raw particle via the silane coupling agent. Examples of the compound of another type having an amino group include amino acids. In this case, the carboxyl group contained in the amino acid is bound to the surface of the raw particle via the siloxane bond and the urea bond, and serves as a polar group.

After the raw particle having a polar group on its surface has been prepared in the particle preparation step as described above, the thermally conductive layer 12 is formed on the surface of the raw particle in the thermally conductive layer formation step. At this time, a direct formation method may be employed in which an inorganic compound to be contained in the thermally conductive layer 12 in the formed filler 10 is arranged, as a raw material, on the surface of the raw particle, or an indirect formation method may be employed in which a raw material for forming an inorganic compound to be contained in the thermally conductive layer 12 is arranged on the surface of the raw particle through chemical reaction as appropriate. In both cases, since the raw particle has a polar group on its surface, the raw material can be bound firmly to the raw particle through electrostatic interaction (ionic bonding) via the polar group or formation of a bond caused by the chemical reaction.

When the direct formation method is employed, the raw material arranged on the surface of the raw particle forms the thermally conductive layer 12 as it is. Examples of the direct formation method include vapor deposition and precipitation. On the other hand, when the indirect formation method is employed, the thermally conductive layer 12 is formed by arranging the raw material on the surface of the raw particle and then initiating chemical reaction. In an example of the indirect formation method, the raw material is bound to a polar group on the surface of the raw particle through interaction such as electrostatic interaction (ionic bonding) or chemical reaction, and then the bound raw material is subjected to chemical reaction to form the thermally conductive layer 12 having a desired composition. In particular, when the raw particle has an acidic group on its surface, firm binding with a raw material containing a metal may be easily achieved.

In the thermally conductive layer formation step, a raw material solution is prepared in which the raw particles are dispersed in a dispersion medium (solvent) and the raw material for forming an inorganic compound of the thermally conductive layer 12 is contained. The raw material for forming an inorganic compound to constitute the thermally conductive layer 12 needs to be present in a liquid form in the raw material solution, and may be dissolved in the dispersion medium (solvent) or be in a molten state. Alternatively, a fine dispersion state is also possible. Hereinafter, an aspect of the raw material solution in which the raw particles are dispersed and the raw material to be contained in the thermally conductive layer 12 is dissolved will be described. In this case, there is no particular limitation on the solvent used to prepare the raw material solution as long as the raw particles are not dissolved therein but are dispersed therein without alteration of a polar group on the surface, and the raw material to be contained in the thermally conductive layer 12 can be dissolved therein. Examples of the solvent include organic solvents such as toluene and tetrahydrofuran (THF), and alcohols such as isobutyl alcohol.

For preparing the raw material solution, it is sufficient that, for example, the raw particles are added to the solvent first, and then the resultant mixture is sufficiently stirred to disperse the raw particles. Next, it is sufficient that the raw material for forming the thermally conductive layer 12 is added to the dispersion liquid containing the raw particles and dissolved by stirring or the like. Through this, the raw material is bound onto the polar group on the surface of the raw particle through interaction such as electrostatic interaction (ionic bonding) or chemical reaction. In the case where decomposition or the like of the raw material is required to enable binding of the raw material to the polar group of the raw particle, or a bond is formed between the raw material and the polar group of the raw particle through chemical reaction, if heating or addition of a reagent is needed for the decomposition or chemical reaction, it is preferable that such an operation is performed as appropriate in combination with stirring.

After the raw material has been bound to the surface of the raw particle, it is sufficient that the raw material is converted to a desired inorganic compound to constitute the thermally conductive layer 12 through chemical reaction. At this time, it is sufficient that an operation depending on the type of the required chemical reaction is performed. For example, it is sufficient that heating, addition of a reagent, (formation of) contact with a gas molecule such as oxygen, or the like is performed in addition to stirring. If the conversion of the raw material can be completed by performing only heating or (formation of) contact with the atmosphere, or both of them, in addition to stirring, it is preferable since the thermally conductive layer 12 can be easily formed.

It is preferable that the product is isolated as appropriate through filtration or the like after the thermally conductive layer 12 has been formed on the surface of the hollow particle 11 in the thermally conductive layer formation step. The thermally conductive filler 10 can be obtained by further performing heating drying or vacuum drying to remove a volatile component.

A substance that can form a metal-containing ion in the dispersion liquid containing the raw particles or on the surface of the raw particle is preferable as the raw material used in the thermally conductive layer formation step. There is no limitation on the specific type of compound, and favorable examples of such a raw material include metal alkoxides and metal carbonates. When a metal alkoxide is used as the raw material, it is sufficient that the metal alkoxide is added to the dispersion liquid containing the raw particles, and the resultant mixture is stirred while being heated. The metal alkoxide is hydrolyzed to form a metal hydrate while alcohol generated. In particular, if a minute amount of a polar group such as an acidic group is present on the surface of the raw particle or in the dispersion medium, the speed of forming the metal hydrate increases therearound. The formed metal hydrate forms an electrostatic bond with the polar group having a negative polarization, such as an acidic group, on the surface of the raw particle, and binds firmly to the surface of the raw particle, in the form of a film. Thereafter, oxidation with oxygen in the atmosphere is caused by heating the reaction solution as appropriate to volatilize the dispersion medium, and thus the thermally conductive filler 10 having the thermally conductive layer 12 containing at least one of a metal hydroxide and a metal oxide is obtained. In many cases, the oxidation in the thermally conductive layer 12 progresses until a metal oxide is formed. There is no limitation on the type of metal alkoxide, and examples thereof include methoxides, ethoxides, and isopropoxides. Aluminum isopropoxide and magnesium ethoxide can be favorably used from the viewpoint of safety and availability.

In the case where a metal carbonate is used as the raw material, when a basic carbonate is added to the dispersion liquid containing the raw particles, a metal hydroxide is formed on the surface of the raw particle and binds firmly to the surface of the raw particle, in the form of a film. Thereafter, as in the case of the alkoxide above, oxidation with oxygen in the atmosphere is caused by heating the reaction solution as appropriate to volatilize the dispersion medium, and thus the thermally conductive filler 10 having the thermally conductive layer 12 containing at least one of a metal hydroxide and a metal oxide is obtained. In many cases, the oxidation in the thermally conductive layer 12 progresses until a metal oxide is formed.

### Thermally Conductive Composite Material

Next, a thermally conductive composite material (also referred to merely as a “composite material” hereinafter) according to an embodiment of the present disclosure will be described. As shown in FIG. 1, a thermally conductive composite material 1 according to the present embodiment contains the above-described thermally conductive filler 10 according to the embodiment of the present disclosure, and the matrix material 2. The filler 10 is dispersed in the matrix material 2.

The composite material 1 according to the present embodiment contains the above-described thermally conductive filler 10 obtained by providing the thermally conductive layer 12 onto the surface of the hollow particle 11, and thus has high thermal conductive properties and excellent heat dissipation properties as a whole due to high thermal conductive properties provided by the thermally conductive layer 12. In addition, the overall specific gravity of the composite material 1 is low due to the effect of the specific gravity of the thermally conductive filler 10 reduced by the hollow particle 11.

There is no limitation on the type of matrix material 2. The matrix material 2 preferably contains an organic polymer, and more preferably contains an organic polymer as a main component. Specific examples of the organic polymer contained in the matrix material 2 include various resins, thermo-plastic elastomers, and rubbers. The organic polymer is not limited to a macromolecule (polymer), and may be a substance with a low polymerization degree, such as an oligomer. When a resin material is used as the matrix material 2, a curable resin, thermo-plastic resin, or solvent-soluble plastic may be used in accordance with a desired application. Examples of the resin contained in the matrix material 2 include olefin-based resins such as polyethylene and polypropylene, halogen-based resins such as polyvinyl chloride, polylactic acid, polystyrene-based resins, polyvinyl acetate, ABS resins, AS resins, acrylic resins, methacrylic resins, polyamide resins, urethane resins, silicone resins, fluororesins, polyvinyl alcohol, polyimide, polyacetal, polycarbonate, modified polyphenylene ether (PPE), polyethylene terephthalate, polybutylene terephthalate, polyphenylene sulfide, and epoxy resins, and copolymers of these resins and polymer alloys. The matrix material 2 may contain only one organic polymer or a plurality of organic polymers. Also, the matrix material 2 may contain additives such as a flame retardant, a bulking agent, and a coloring agent as appropriate in addition to the organic polymer.

The specific gravity of the matrix material 2 itself is not particularly limited, but is preferably suppressed to 1.5 or less from the viewpoint of reducing the overall specific gravity of the composite material 1 to which the filler 10 has been added. The lower limit of the specific gravity of the matrix material 2 is not particularly set. When an organic polymer is used as the matrix material 2, the specific gravity thereof is about 0.8 or more. Also, the thermal conductivity of the matrix material 2 itself is not particularly limited, but is preferably 0.1 W/(m·K) or more from the viewpoint of keeping the overall thermal conductivity of the composite material 1 to which the filler 10 has been added high. The upper limit of thermal conductivity of the matrix material 2 is not particularly set. When an organic polymer is used as the matrix material 2, the thermal conductivity thereof is about 0.6 W/(m·K) or less. The specific gravities of the matrix material 2 and the composite material 1 can be measured using a water displacement method and the like. The thermal conductivities of these materials can be measured using a laser flash method, a hot wire method, and the like.

It is preferable that the content of the filler 10 in the composite material 1 according to the present embodiment is determined as appropriate such that the desired overall specific gravity and thermal conductive properties of the composite material 1 are obtained. The larger the content of the filler 10 is, the higher the thermal conductive properties of the composite material 1 are. Therefore, it is preferable that the content of the filler 10 is determined with which desired thermal conductive properties are obtainable, as the lower limit. For example, it is preferable that the content of the filler 10 is determined such that the thermal conductivity of the composite material 1 is 1.5 or more times, preferably 2 or more times, more preferably 3 or more times, and even more preferably 4 or more times as large as the thermal conductivity of the matrix material 2 free of the filler 10. Alternatively, it is preferable that the content of the filler 10 is determined such that the thermal conductivity of the composite material 1 is preferably 0.6 W/(m·K) or more, more preferably 0.9 W/(m·K) or more, and even more preferably 1.2 W/(m·K) or more. It is more preferable that the composite material 1 has a higher thermal conductivity; however the thermal conductivity of the composite material 1 is preferably suppressed to 50 or less times, and more preferably 30 or less times, as high as the thermal conductivity of the matrix material 2, or preferably 8.0 W/(m·K) or less and more preferably 5.0 W/(m·K) or less, from the viewpoint of avoiding an increase in the specific gravity due to the addition of an excessive amount of filler 10.

The upper limit of the content of the filler 10 in the composite material 1 is not particularly set. The content of the filler 10 is determined such that the specific gravity of the composite material 1 is preferably 1.3 or less times, preferably 1.2 or less times, as high as the specific gravity of the matrix material 2 free of the filler 10. It is more preferable that the specific gravity of the composite material 1 is lower than or equal to the specific gravity of the matrix material 2 free of the filler 10. Alternatively, the content of the filler 10 is determined such that the specific gravity value of the composite material 1 is preferably suppressed to 1.8 or less, and more preferably 1.5 or less. It is preferable that the composite material 1 has a lower specific gravity, however no lowest limitation is set to the specific gravity of the composite material 1.

When the content of the filler 10 is specified by the ratio of the filler 10 in the entire composite material 1, the content of the filler 10 is preferably about 30 vol % or more from the viewpoint of sufficiently enhancing the thermal conductive properties of the composite material 1. On the other hand, the content of the filler 10 is preferably 60 vol % or less from the viewpoint of suppressing an increase in the specific gravity of the composite material 1. It is preferable to select the content of the filler 10 such that the thermally conductive layers 12 of the adjacent filler particles 10 come into contact with each other and thus a thermal conduction path is formed as shown in FIG. 1. When the content of the filler 10 in the composite material 1 is specified by the content of the inorganic compound, namely the volume ratio of the inorganic compound forming the thermally conductive layer 12 in the entire composite material 1, the content thereof is preferably 0.5 vol % or more and more preferably 5 vol % or more, and is also preferably 20 vol % or less.

As described above, the composite material 1 according to the present embodiment has both high thermal conductive properties and a low specific gravity. Accordingly, the composite material 1 can be favorably used as a material included in various members that are required to be light and have heat dissipation properties, such as a wire harness, which will be described below. The composite material 1 according to the present embodiment can be formed by mixing the powdery filler 10 formed according to the above-described forming method to the matrix material 2 at a predetermined blend ratio.

### Wire Harness

Lastly, a wire harness according to an embodiment of the present disclosure will be described. The wire harness according to the present embodiment contains the above-described thermally conductive composite material 1 according to the embodiment of the present disclosure. As shown in FIG. 2, a wire harness 5 has a configuration in which a connector 52 that includes a connection terminal (not shown) is provided at a terminal portion of an insulated electric wire 51 in which an insulating coating is provided on the outer circumference of an electric wire conductor. The wire harness 5 may include a plurality of insulated electric wires 51 bundled together. In this case, a tape 53 can be used as a sheathing member for bundling the insulated electric wires 51.

In the wire harness 5 according to the present embodiment, the above-described composite material 1 according to the embodiment of the present disclosure can be contained in various members that are required to have heat dissipation properties. It is preferable to mainly use the composite material 1 formed by adding the filler 10 into an organic polymer serving as the matrix material 2 in an insulating member. Examples of such an insulating member include an insulating coating contained in the insulated electric wire 51, sheathing members such as the tape 53 and a protective tube that are arranged outside the insulated electric wire 51, adhesives used to fix constituent members or seal a space between constituent members against water, and a connector housing constituting the connector 52. The composite material 1 may be arranged between a protective tube such as a corrugated tube and the insulated electric wire 51.

In recent years, there is a trend in the automotive field, particularly electric cars and hybrid cars, where an electric current applied to an electric wire is increased, and thus the amount of heat generated by the electric wire is increased. Also, many electric wires and electric connection members are arranged in proximity to each other. In these cases, it is important that various members of the wire harness 5 have high heat dissipation properties from the viewpoint of reducing the influence of heat released from the electric wires and the electric connection members. If a member of the wire harness 5 that may be affected by released heat is formed to contain the above-mentioned composite material 1 having high thermal conductive properties, heat release may be performed with efficiency. In addition, weight reduction of constituent members is a critical issue in the automotive field. The utilization of the above-mentioned composite material 1 having a reduced specific gravity also contributes to weight reduction of the wire harness 5.

### EXAMPLES

Hereinafter, examples will be described. The present invention is not limited to these examples. Here, a thermally conductive filler having a configuration in which a thermally conductive layer was provided on the surface of a hollow particle was produced, and the specific gravity and the thermal conductive properties thereof were evaluated. In the following descriptions, samples were produced and evaluated in the atmosphere at room temperature unless otherwise stated.

### [Test Methods]

### (1) Preparation of Filler

First, a plurality of types of fillers having a configuration in which a thermally conductive layer was provided on the surface of a hollow particle were prepared. In order to produce a filler, a raw particle was first subjected to surface treatment as appropriate in the particle preparation step, and then a thermally conductive layer was formed on the surface of the raw particle in the thermally conductive layer formation step.

### (1-1) Particle Preparation Step

Raw materials listed below were prepared to produce hollow particles to be contained in fillers.

### Hollow Glass Particle

G6020: hollow particle made of soda lime borosilicate glass (“Glass Bubbles K20” produced by 3M Company); the median diameter: 60 μm; the specific gravity: 0.20
G4525: hollow particle made of borosilicate glass (“Sphericel 25P45” produced by Potters-Ballotini Co., Ltd.); the median diameter: 45 μm; the specific gravity: 0.25
G2046 (“Glass Bubbles iM16K” produced by 3M Company): hollow particle made of soda lime borosilicate glass; the median diameter: 20 μm; the specific gravity: 0.46

### Surface Treating Agent

3-Aminopropyltriethoxysilane (APES)

(C₂H₅O)₃Si—C₃H₆—NH₂
Tetraethoxysilane (TEOS)

Si(OC₂H₅)₄
Vinyltriethoxysilane (VIES)

(C₂H₅O)₃Si—CH═CH₂
3-Isocyanatopropyltriethoxysilane (IPES)

(C₂H₅O)₃Si—C₃H₆—N═C═O
DL-Alanine

H₂N—CH(CH₂)—COOH
Hexamethyldisilazane (HMDS)

(CH₃)₃Si—NH—Si(CH₃)₃

Various types of surface-treated particles were produced by performing surface treatment on the above-mentioned hollow glass particles using the above-mentioned surface treating agents as described below.
G60-A: 5 g of G6020 and 100 mL of acetone were put into a recovery flask and were gently stirred at room temperature to form a suspension. Then, 0.5 g of APES was added to the suspension while the suspension continued. The suspension was stirred for 2 hours at room temperature, and then a condenser was attached to the flask. 20 mL of pure water was added, and the mixture was stirred at 50° C. for 24 hours. Thereafter, the mixture was filtrated, and the residue was air-dried and was then further heated in an oven at 140° C. for 24 hours. By these processes, G6020 surface-treated with aminopropyltriethoxysilane was obtained as white powder.
G60-T: G6020 surface-treated with tetraethoxysilane was obtained as white powder in the same manner as in the G60-A forming method above, except that TEOS was used instead of APES.
G60-V: G6020 surface treated with vinyltriethoxysilane was obtained as white powder in the same manner as in the G60-A forming method above, except that VTES was used instead of APES.
G60-I: G6020 surface treated with isocyanatopropyltriethoxysilane was obtained as white powder in the same manner as in the G60-A forming method above, except that IPES was used instead of APES.
G60-IA: 5 g of G60-I obtained as described above and 50 mL of acetone were put into a recovery flask and were gently stirred at room temperature to form a suspension. Then, 10 g of an aqueous solution containing DL-alanine at a concentration of 2 mass % was added to the suspension, and the mixture was stirred at 50° C. for 24 hours. Thereafter, the mixture was filtrated, and the residue was air-dried and was then further heated in an oven at 140° C. for 24 hours. G6020 surface treated with carboxylic acid via isocyanate was obtained as white powder.
G45-IA: A product was obtained by performing the method for producing G60-I described above using G4525 instead of G6020. G4520 surface-treated with carboxylic acid via isocyanate was obtained as white powder by performing the method for producing G60-IA described above using the product instead of G60-I.
G20-IA: A product was obtained by performing the method for producing G60-I described above using G2046 instead of G6020. G2046 surface-treated with carboxylic acid via isocyanate was obtained as white powder by performing the method for producing G60-IA described above using the product instead of G60-I.
G60-H: G6020 surface-treated with hexamethyldisilazane was obtained as white powder in the same manner as in the method for producing G60-A described above, except that HMDS was used instead of APES.

Thus, various types of surface-treated particles were prepared. When the specific gravity of each of the obtained surface-treated particles was evaluated using an electronic densimeter, there was no change before and after the surface treatment. That is, it was confirmed that the surface treatment as mentioned above had no influence on the specific gravity.

### (1-2) Thermally Conductive Layer Formation Step

The various types of surface-treated particles produced as mentioned above and G6020 that had not undergone the surface treatment were used as the raw particles, and thermally conductive layers containing an aluminum oxide were formed on the raw particles. Specifically, each type of raw particle and aluminum isopropoxide (produced by Tokyo Chemical Industry Co., Ltd.) were added to isobutyl alcohol, and the resultant mixture was gently stirred under reflux at 110° C. Table 1 below shows the amounts of the raw particles and aluminum isopropoxide fed at this time. In Table 1, the fillers whose names are shown as the names of their raw particles followed by “F1” were prepared by adjusting the addition amount of aluminum isopropoxide such that the amount of alumina in the formed filler in terms of the volume ratio was 25 vol % and, in terms of the thickness, was 9% of the particle diameter of the raw particle. On the other hand, the fillers whose names are shown as the names of their raw particles followed by “F2” were prepared by adjusting the addition amount of aluminum isopropoxide such that the amount of alumina in the formed filler in terms of the volume ratio was 10 vol % and, in terms of the thickness, was 3.5% of the particle diameter of the raw particle.

The mixture was stirred for 1 hour while heated at 110° C., and then 10 mL of pure water was added thereto. The resultant mixture was further stirred for 40 hours under reflux while being heated. Thereafter, the reaction solution was cooled to room temperature and was then filtrated, and the residue was air-dried. The obtained solid component was dried in an oven at 140° C. for 48 hours. Thus, various fillers were obtained.

Table 1 below summarizes the types, specific gravities, and feed amounts of the raw particles used as the raw materials to prepare the fillers, and the addition amounts of aluminum isopropoxide. Table 1 also shows the specific gravities and the specific gravity ratios R of the thermally conductive layers. Here, the specific gravity of the filler was determined through calculation based on the mass ratio of the raw material on the assumption that all of the aluminum isopropoxide formed alumina. However, the actual fillers may contain, as alumina, not only alumina formed as a thermally conductive layer on the surface of the raw particle but also alumina formed in another form such as an alumina particle that is formed as a particle independent of the raw particle. The fillers whose specific gravities were calculated here included all of these forms of alumina. The specific gravity ratios R of the thermally conductive layers were determined based on the specific gravity values using Formula (1) above. It was confirmed that the composition of the thermally conductive layer formed using aluminum isopropoxide formed according to the above-mentioned synthesis method was mostly constituted by only alumina through the SEM-EDX analysis (energy dispersive X-ray analysis using a scanning electron microscope) performed for the thermally conductive layer similarly formed on the surface of another type of fine particle. “G60-F1” was also prepared as the filler in addition to the various fillers shown in Table 1 by using G6020 that had not undergone the surface treatment as the raw particle and performing the same thermally conductive layer formation step as described above.

TABLE 1

| | Raw particle | | | Aluminum | | |
|---|---|---|---|---|---|---|
| | | | Feed | isopropoxide | Specific | Specific gravity ratio R of |
| | | Specific | amount | Feed amount | gravity of | thermally conductive |
| Type of filler | Type | gravity | (g) | (g) | filler | layer (%) |
| G60A-F1 | G60-A | 0.20 | 1.0 | 26.7 | 1.15 | 475 |
| G60T-F1 | G60-T | 0.20 | 1.0 | 26.7 | 1.15 | 475 |
| G60V-F1 | G60-V | 0.20 | 1.0 | 26.7 | 1.15 | 475 |
| G60I-F1 | G60-I | 0.20 | 1.0 | 26.7 | 1.15 | 475 |
| G60IA-F1 | G60-IA | 0.20 | 1.0 | 26.7 | 1.15 | 475 |
| G45IA-F1 | G45-IA | 0.25 | 1.3 | 27.3 | 1.18 | 371 |
| G20IA-F1 | G20-IA | 0.46 | 2.3 | 26.2 | 1.33 | 190 |
| G60H-F1 | G60-H | 0.20 | 1.0 | 26.7 | 1.15 | 475 |
| G60T-F2 | G60-T | 0.20 | 1.2 | 10.7 | 0.58 | 191 |
| G60IA-F2 | G60-IA | 0.20 | 1.2 | 10.7 | 0.58 | 191 |

*Alumina volume ratio F1: 25 vol %, F2: 10 vol %

### (1-3) Reference Sample

The following fillers were also prepared as referential fillers for comparison with the fillers formed as described above.
Alumina filler: Roundish Alumina (AS-50) produced by Showa Denko K.K.
G6020: G6020 used as the raw material for the surface treatment in the description above was also used as a referential filler as it is.

### (2) Preparation of Composite Material

Each of the fillers prepared as described above was dispersed in a matrix material. Thus, composite materials according to Samples A1 to A10 and Samples B1 to B5 were prepared. Here, a cured product of the following two-component epoxy resin was used as the matrix material of the composite materials.
Epoxy main agent: Bisphenol A glycidyl ether (“jER828” produced by Mitsubishi Chemical Corporation; epoxy equivalent: 190 g/eq.)
Epoxy curing agent: Amine-type (“ST12” produced by Mitsubishi Chemical Corporation; amine value: 345 to 385 KOH mg/g)

Each of the various types of fillers, the epoxy main agent, and the epoxy curing agent were mixed at the mass ratio shown in Table 2 below in an agate mortar at a normal temperature, and the mixture was defoamed for 1 minute under vacuum at the normal temperature. Then, the mixture was heated at 100° C. for 10 minutes using a heat-press molding machine and was thus cured. A cured resin product test piece (10 mm×10 mm×1 mm) was prepared by cutting a portion of the cured product in which no bubbles were visually confirmed. Regarding Sample B1, a filler was not added, and the cured resin product test piece was prepared only using the epoxy resin.

### (3) Evaluation of Properties of Composite Material

The specific gravity and thermal conductivity of each of the cured resin product test pieces prepared as described above were measured. The specific gravity was measured using a water displacement method. The thermal conductivity was measured using a laser flash method with a heat-transfer apparatus (“LFA447” produced by NETZSCH). Furthermore, the cross sections of the test pieces of Samples A1 to A5 were observed using a scanning electron microscope (SEM), and thus the filler dispersion states were evaluated. As described above, the formed filler contained, as aluminum compounds such as alumina, not only an aluminum compound formed as a layer on the surface of the raw particle but also an aluminum compound formed as a particle independent of the raw particle. However, the properties evaluated here were measured using the samples in which all the aluminum compound components were added, as a filler, to the matrix material.

### [Test Results]

The specific gravities and thermal conductivities of the composite materials according to Samples A1 to A10 and Samples B1 to B5 were summarized in Table 2 together with the blend ratios between the fillers and the matrix material (unit: mass %), the blend amounts of the fillers (unit: vol %), and the alumina contents (unit: vol %). Here, the alumina content refers to the overall amount of alumina contained in the composite material, and was calculated from the volume ratio of the thermally conductive layer in the filler.

TABLE 2

| Specific | Sample No. | | | | | | | | | | | | | | |
|---|---|---|---|---|---|---|---|---|---|---|---|---|---|---|---|
| gravity | A1 | A2 | A3 | A4 | A4 | A6 | A7 | A8 | A8 | A10 | B1 | B2 | B3 | B4 | B5 |

| | | | | | | | | | | | | | | | | |
|---|---|---|---|---|---|---|---|---|---|---|---|---|---|---|---|---|
| Filler | G60A-F1 | 1.15 | 39 | | | | | | | | | | | | | |
| | G60T-F1 | 1.15 | | 39 | | | | | | | | | | | | |
| | G60V-F1 | 1.15 | | | 39 | | | | | | | | | | | |
| | G60I-F1 | 1.15 | | | | 39 | | | | | | | | | | |
| | G60IA-F1 | 1.15 | | | | | 39 | | | | | | | | | |
| | G45IA-F1 | 1.18 | | | | | | 40 | | | | | | | | |
| | G20IA-F1 | 1.33 | | | | | | | 43 | | | | | | | |
| | G60H-F1 | 1.15 | | | | | | | | 39 | | | | | | |
| | G60T-F2 | 0.58 | | | | | | | | | 25 | | | | | |
| | G60IA-F2 | 0.58 | | | | | | | | | | 25 | | | | |
| | G6020 | 0.20 | | | | | | | | | | | 10 | | | |
| | G60-F1 | 1.15 | | | | | | | | | | | | 39 | | |
| | Alumina | 4.00 | | | | | | | | | | | | | 27 | 69 |

| | | | | | | | | | | | | | | | | |
|---|---|---|---|---|---|---|---|---|---|---|---|---|---|---|---|---|
| Epoxy main agent | 1.17 | 41 | 41 | 41 | 41 | 41. | 40 | 38 | 41 | 50 | 50 | 67 | 60 | 41 | 49 | 21 |
| Epoxy curing agent | | 20 | 20 | 20 | 20 | 20 | 20 | 19 | 20 | 25 | 25 | 33 | 30 | 20 | 24 | 10 |

| | | | | | | | | | | | | | | | |
|---|---|---|---|---|---|---|---|---|---|---|---|---|---|---|---|
| Blend amount of filler (vol %) | 40 | 40 | 40 | 40 | 40 | 40 | 40 | 40 | 40 | 40 | 0 | 40 | 40 | 10 | 40 |
| Alumina content (vol %) | 10 | 10 | 10 | 10 | 10 | 10 | 10 | 10 | 4.0 | 4.0 | 0 | 0 | 10 | 10 | 40 |
| Specific gravity | 1.16 | 1.16 | 1.16 | 1.16 | 1.1.6 | 1.16 | 1.16 | 1.16 | 0.93 | 0.93 | 1.17 | 0.77 | 1.16 | 1.45 | 2.29 |
| Thermal conductivity (W/m · K) | 0.7 | 1.4 | 0.8 | 1.3 | 1.5 | 1.5 | 1.5 | 0.5 | 0.7 | 0.9 | 0.3 | 0.2 | 0.3 | 0.4 | 1.7 |

As shown in Table 2, in each case of Samples A1 to A10 obtained by adding, to the matrix material, the fillers formed by providing a thermally conductive layer containing alumina as the main component on the surface of a hollow particle to which a polar group had been introduced through the surface treatment, although the addition amount of the filler was as large as 40 vol %, the specific gravity of each Sample was smaller than the specific gravity of filler-free Sample B1.

Moreover, all of Samples A1 to A10 had a thermal conductivity of 0.5 W/(m·K) or higher. These values are 1.5 or more times as high as the thermal conductivity of filler-free Sample B1. It appeared from these results that, in the cases of Samples A1 to A10 to which the fillers obtained by forming a thermally conductive layer on the surface of a hollow particle had been added, the filler contained a hollow particle having a low specific gravity, and therefore, the overall thermal conductivity of the composite material to which the filler had been added could be increased while the specific gravity thereof was reduced. It is conceivable that, since the hollow particle had a polar group on its surface, the thermally conductive layer could be stably formed on the surface of the hollow particle to densely cover the surface of the hollow particle. It is understood that, since the thermally conductive layers of the surfaces of the adjacent fillers were made in contact with each other due to the volume effect of the hollow particles, a thermal conduction path was formed between the filler particles, and the thermal conductivity could be effectively enhanced.

Here, Samples B2 to B5 are examined. In Sample B2, a hollow glass particle (G6020) was added to the matrix material as it was, and the specific gravity was smaller than that of filler-free Sample B1. However, an inorganic substance having high thermal conductive properties, such as alumina, was not contained in B2, and thus the thermal conductivity of B2 was not higher but rather lower than that of Sample B1. The thermal conductivity of glass is about 1.0 W/(m·K) and is higher than the thermal conductivity of the matrix material. However, the hollow particle was employed and thus air was contained therein, and it is thus understood that phonon scattering occurred inside the particle, and thermal conduction via the particles was unlikely to occur. Accordingly, a hollow glass particle cannot be used as a thermally conductive filler as it is.

Sample B3 was different from Sample B2 in that a thermally conductive layer was formed on a hollow glass particle, and then the particle was added to a matrix resin. However, although the alumina content in Sample B3 was the same as the amount thereof in Samples A1 to A8, the thermal conductivity was not increased compared with filler-free Sample B1. This indicates that, since the surface treatment for introducing a polar group to the surface of the glass particle was not performed unlike Samples A1 to A8, alumina attached to the surface of the glass particle, but did not effectively function to form a thermal conduction path. It is conceivable that alumina did not accumulate and form a layer that continuously covered the surface of the glass particle, but small regions in which alumina was formed were dispersed on the surface of the glass particle.

An alumina filler, which is widely used as a thermally conductive filler, was added to Sample B4 in an amount of 10 vol %. This addition amount was the same as the alumina content in Samples A1 to A8. However, the thermal conductivity of Sample B4 was slightly higher than that of filler-free Sample B1, and lower than those of Samples A1 to A8. It is conceivable that this is because the contact area between the filler particles was small due to the small volume of the filler in the composite material, and thus a thermal conduction path could not be effectively formed between the filler particles.

Although an alumina filler was added to Sample B5 as in the case of Sample B4, the blend amount was 40 vol %. This blend amount was the same as the filler blend amount (volume ratio of the filler) in Samples A1 to A8. The thermal conductivity of Sample B5 was significantly higher than that of filler-free Sample B1. The reasons are that the contact area between the filler particles was increased due to the increased addition amount of the alumina filler compared with Sample B4, and thus an effective thermal conduction path was formed. However, the specific gravity of the composite material was about twice as high as that of Sample B1 due to the increased volume of alumina itself. It can be said from the evaluation results of Samples B4 and B5 that it is difficult to achieve a low specific gravity and high thermal conductivity using a filler made of only alumina.

Lastly, Samples A1 to A10 are compared with one another. First, Samples A1 to A5 and A8 differed from one another in the type of functional group introduced to the surface of the raw particle included in the filler through the surface treatment. The thermal conductivities of Samples A1 to A5 were higher than that of Sample A8. It is conceivable that, since the silane coupling agents having an alkoxysilyl group were used as a surface treating agent in Samples A1 to A5, a molecule having a polar group could be bound firmly onto the surface of the glass particle at a high density, and thus the thermally conductive layer could be formed on the surface of the glass particle having an increased polarity. On the other hand, it is conceivable that, since the surface treating agent used in Sample A8 did not have an alkoxysilyl group and was thus incapable of forming a siloxane bond with the glass surface, the polarity of the glass surface was lower than those in Samples A1 to A5, and the efficiency of forming a thermally conductive layer was thus reduced.

Among Samples A1 to A5, the thermal conductivity was the lowest in Sample A1, and the second lowest in Sample A3. The thermal conductivities of Samples A2, A4, and A5 were significantly higher than those of Samples A1 and A3. It is conceivable that, the hollow particles of Samples A2, A4, and A5 had a silanol group (generated through hydrolysis of an alkoxysilyl group), an isocyanate group, and a carboxyl group, respectively, of a high polarity group, on their surfaces, and thus the thermally conductive layers could be formed with high efficiency due to the formation of ionic bonds between the polar group and a metal-containing cation. On the other hand, the surface treating agent used in Sample A3 only had, as functional groups, a vinyl group, which has a low polarity, in addition to an alkoxysilyl group. An amino group, which is a basic group, in addition to an alkoxysilyl group was introduced to the surface treating agent in Sample A1. In Samples A1 and A3, the thermally conductive layer was formed through electrostatic interaction between the alkoxysilyl group or the polarized structure of a siloxane bond derived from the alkoxysilyl group and the metal-containing cation, but the polarity of the surface of the raw particle was not as high as those in the above-mentioned cases of Samples A2, A4, and A5 in which the acidity of the functional group was utilized, and thus the efficiency of forming a thermally conductive layer on the surface of the raw particle was reduced. With respect to Samples A1 to A5, the specific gravities were the same, and the amounts of the aluminum compound contained therein were the same. However, in Samples A1 and A3, the amount of the aluminum compound generated as the thermally conductive layer in the form of a uniform layer on the surface of the raw particle was small, and thus it is conceivable that a component that did not effectively contribute to the enhancement of the thermal conductivity of the composite material, such as a component forming a particle that is independent of the raw particle, or a component that was generated ununiformly on the surface of the raw particle, was generated instead.

As a result of evaluating the dispersion states of the filler particles by observing the cross sections of Samples A1 to A5 using an SEM, filler aggregates were observed in Samples A1 and A4. On the other hand, the dispersion state of the filler was particularly excellent in Sample A5. It is conceivable that aggregates of the raw particles were formed in the filler forming process due to the amino group forming a hydrogen bond in Sample A1 and an isocyanate group remaining reactivity in Sample A4, and these aggregates remained in the formed fillers. It is conceivable that, in Sample A5, a carboxyl group introduced as a polar group did not cause the aggregation through the formation of a hydrogen bond or chemical reaction, and therefore, the filler was highly dispersible. As a result, the composite material of Sample A5 shows particularly high thermal conductive properties.

Samples A5 to A7 differed from one another in the particle diameter of the raw particle included in the filler. However, Samples A5 to A7 had the same specific gravity and the same thermal conductivity. It was found from these results that the particle diameter of the filler particle did not have a significant influence on the specific gravity and thermal conductive properties of the composite material. Accordingly, it can be said that the particle diameter of the composite particle may be selected as appropriate in consideration of ease of dispersion into the matrix material, the material strength, the specific gravity, and the like. In this case, the addition amount of the filler may be determined depending on the filler particle diameter by employing the filler blend amount (unit: vol %) or alumina amount (unit: vol %) as an indicator.

Samples A9 and A10 differed from Samples A2 and A5 in the amount of the thermally conductive layer formed in the filler. The specific gravities of Samples A9 and A10 were lower than those of Samples A2 and A5 in response to a reduction in the thickness of the formed thermally conductive layer, and thus the thermal conductivities of Samples A9 and A10 were also lower than those of Samples A2 and A5. However, although the alumina contents were as small as 4.0 vol %, both Samples A9 and A10 had a higher thermal conductivity than Sample B4 in which the alumina content was 10 vol %. It was found from these results that if the thermally conductive layer is formed on the surface of the hollow particle to secure the overall volume of the filler, the thermally conductive layer, even in a small amount, contributes to improve thermal conduction.

Although the embodiments of the present invention have been described in detail, the present invention is not limited to the above embodiments, and various modifications can be made without departing from the gist of the present invention.

### LIST OF REFERENCE NUMERALS

1 (Thermally conductive) Composite material
10 (Thermally conductive) Filler
11 Hollow particle
11a Cavity
11b Shell
12 Thermally conductive layer
2 Matrix material
5 Wire harness
51 Insulated electric wire
52 Connector
53 Tape

1. A thermally conductive filler comprising:
a hollow particle having a polar group on its surface; and
a thermally conductive layer comprising an inorganic compound that covers the surface of the hollow particle,
wherein the thermally conductive layer is in the form of a film of the inorganic compound that is attached to the surface of the hollow particle.

2. The thermally conductive filler according to claim 1,
wherein the polar group is an acidic group.

3. The thermally conductive filler according to claim 1,
wherein the polar group is bound to the surface of the hollow particle via a siloxane bond.

4. The thermally conductive filler according to claim 1,
wherein the hollow particle is formed as a hollow body made of a material comprising an inorganic compound that is different from the inorganic compound contained in the thermally conductive layer, or a material containing an organic polymer.

5. The thermally conductive filler according to claim 1,
wherein the hollow particle is formed as a hollow body made of glass surface-treated with a polar group.

6. The thermally conductive filler according to claim 1,
wherein the thermally conductive layer includes a compound containing at least one of Al or Mg.

7. The thermally conductive filler according to claim 1, having a specific gravity of 1.5 or lower.

8. A thermally conductive composite material comprising:
the thermally conductive filler according to claim 1;
and a matrix material,
wherein the thermally conductive filler is dispersed in the matrix material.

9. The thermally conductive composite material according to claim 8,
wherein the matrix material contains an organic polymer.

10. The thermally conductive composite material according to claim 8, having a specific gravity of 1.5 or lower.

11. The thermally conductive composite material according to claim 8, having a thermal conductivity of 0.9 W/(m·K) or higher at room temperature.

12. A wire harness comprising the thermally conductive composite material according to claim 8.

13. A method for manufacturing a thermally conductive filler capable of being used to manufacture the thermally conductive filler according to claim 1,
wherein the method uses a raw material for forming the thermally conductive layer as it is or through chemical reaction, and a raw particle formed as a hollow particle having a polar group on its surface, and the method comprises a step of binding the raw material onto the polar group on the surface of the raw particle.

14. The method for manufacturing a thermally conductive filler according to claim 13,
wherein the raw material is at least one of a metal alkoxide or a metal carbonate.

15. The method for manufacturing a thermally conductive filler according to claim 14,
wherein a metal hydrate or metal hydroxide is formed from the raw material in the state of a film, bound to the surface of the raw particle, and is oxidized with oxygen in the atmosphere to form the thermally conductive layer containing at least one of a metal hydroxide or metal oxide.
